(19) United States
(12) Patent Application Publication
(10) Pub. No.: US 2018/0231229 A1
(43) Pub. Date: Aug. 16, 2018

(54) Light String Compaction System

(71) Applicant: James Emory Welch, III, Jacksonville, FL (US)

(72) Inventor: James Emory Welch, III, Jacksonville, FL (US)

(21) Appl. No.: 15/433,919

(22) Filed: Feb. 15, 2017

(51) Int. Cl. F21V 27/00; F21S 4/10

(52) U.S. Cl. CPC F21V 27/00; F21S 4/10

(57) ABSTRACT

A light string storage system. The invention is to be made integral to light strings or to be attached to existing light strings in order to compact the light string in a manner in which it can be stored without being tangled. A lead, which extends through a series of guides attached at the mid-points between lights on the string, when pulled will cause the light string to compact in the manner in which it was packaged from the manufacturer and be able to be stored completely tangle-free.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable.

### BACKGROUND OF THE INVENTION

### 1. Field of the Invention

This invention relates to the field of light strings. More specifically, the invention comprises of a system to be applied to light strings.

### 2. Description of the Related Art

For as many years as light strings, specifically holiday light strings, have existed, consumers have had a need for a system to simplify the process of storing their light strings in a manner that also prevents tangling. Currently, light strings come packaged from the manufacturer compacted in a fashion, which the light sources alternate from top to bottom, etc.; i.e. such that in the process of stretching out the light string it would form a shape similar to several consecutive V's with a light source being present at each vertex.

Typically, however, a consumer does not store their light string in this fashion because of the time required to compact the light string in that manner by hand. This results in the consumer coiling their light string like an extension cord causing the light string to be tangled and uncooperative upon unpacking for next use.

Known solutions that enable light strings to be stored without tangling include do-it-yourself fixes such as a piece of cardboard with slots to hold the lights in place, light reels/spools, systems that bag light strings in a long plastic bag, as well as an invention similar to this one in which cylindrical guides are attached to each light socket and mate with one another when pulled tight. All of these solutions lack the simplicity and utility that the present invention will provide. Do-it-yourself type solutions exist because there is a problem that is not solved by the manufacturer through design improvements.

Light reels and spools work well to store light strings in a manner that prevents them from becoming tangled, but they are bulky, increasing the storage space needed. They are also typically stored while the light string is in use, requiring more time and effort than the solution the present invention proposes.

Light string bagging systems present a cumbersome and involved solution to a very simple problem. The storage space required for the system along with the effort required to utilize the system make these systems hardly more desirable than dealing with the hassle of untangling light strings at each use.

A lapsed patent exists that claims an invention comprising a series of hollow cylinders attached to each individual light socket and a lead that is threaded through each. When the lead is pulled against the light string the light string compacts and pulls the cylinders together until the cylinders mate to one another through a concave to convex interface or something similar. The result of this action is a semi-rigid structure that is as long as the length of all the individual cylinders combined, with bunches of wire forming U shapes on the underside of the sockets. Light strings do not come packaged in this manner, making this solution impractical.

### BRIEF SUMMARY OF THE PRESENT INVENTION

The present invention comprises a system of several guides and a lead that enables a light string to be compacted by pulling on said lead. Guides, which should be attached to the light string at each mid-point between two light sources, serve to contain the lead. The lead will be rigidly attached to either the last guide, last meaning the light furthest away from the male plug, or a point of the light string between the last light and the female plug if on a light string that is designed for multiple light strings to be able to connect to each other, i.e. holiday light strings. The lead will be free on the opposite end. When said lead is pulled at the free end against the light string, the light string will be forced to compact on itself in the manner in which it was packaged.

### BRIEF DESCRIPTION OF THE DRAWINGS

FIG. 1 is a view of an extended light string with present invention

FIG. 2 is a view of a light string being compacted with present invention

FIG. 3 is a view of a light string compacted with present invention

FIG. 4 is a view of the attached end of the lead when attached to light string

FIG. 5 is a view of the attached end of the lead when attached to guide

REFERENCE NUMERALS IN THE DRAWINGS

| | | | |
|---|---|---|---|
| 10 | Light string with present invention | 12 | Light socket |
| 14 | Light source | 16 | Wires |
| 18 | Mid-point between light sockets | 20 | Guide |
| 22 | Lead | 24 | Attached end of lead |
| 26 | Free end of lead | 28 | Female plug |
| 30 | Male plug | 32 | Clip attachment point |
| 34 | Lead attachment point | | |

### DETAILED DESCRIPTION OF THE INVENTION

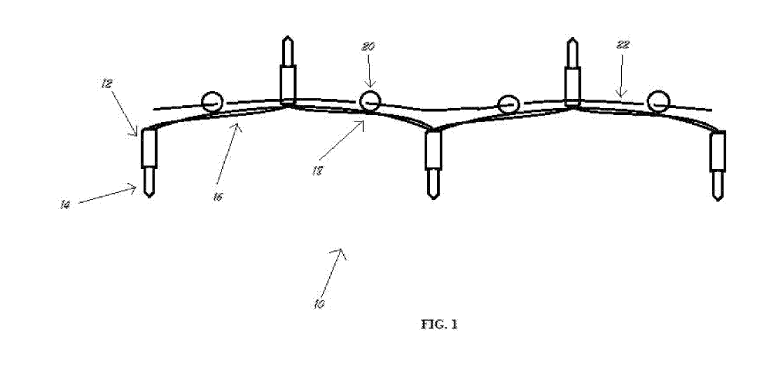

FIG. 1 shows a typical section of a light string with present invention 10 in an extended, or in use, state. A plurality of guides 20, which should have a through hole at least bigger than the diameter of the lead 22 ideally should be made of plastic, but could be made of any number of metals, ceramics, or other rigid material, are attached to the wires 16 at the mid-points between light sockets 18 by means of shrink wrap, thread, clip, molding, or other efficient means of attaching guides 20 so as to prevent them from sliding closer to one light socket 12. The best method of attachment will not only be economic to manufacture and assemble, but also will create no, or very little, hindrance to the lead 22 moving through the guides 20. The lead 22, is preferably nylon cord, but could be ribbon, rope, string, or other cord-like material.

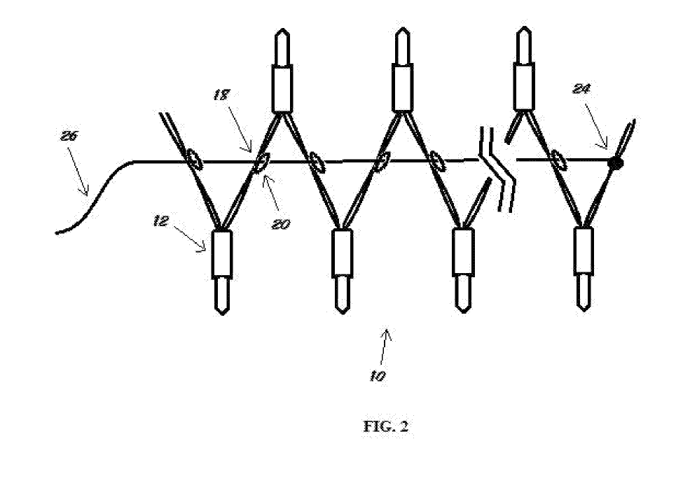

FIG. 2 shows a light string with present invention 10 in the process of being compacted by the present invention. The lead 22 has an attached end of lead 24 and is long enough to extend from that end through the holes in each of the plurality of guides 20 while the light string with present invention 10 is in an extended state. Opposite to the attached end of lead 24 is the free end of lead 26, which may have a knot, toggle, or other attachment at the very end to prevent the lead 22 from slipping back through any of the guides 20. As the guides 20 are pushed towards the attached end of lead 24 (to the right in FIG. 2) and the lead 22 is pulled in the opposite direction, the light string with present invention 10 begins to compact bringing the guides 20 closer together.

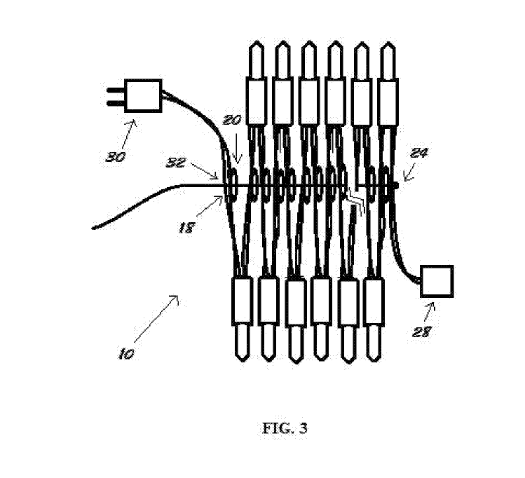

FIG. 3 shows a light string with present invention 10 fully compacted by the present invention. In the compacted state, the guides 20 have been drawn together towards the attached end of lead 24 to the point where each guide 20 is touching the guide 20 on either side of it and the lead 22 is taut from the attached end of lead 24 to the clip attachment point 32, which is where an optional, but encouraged, means of securing the lead 22 such as a bobby-pin style clip, clothes pin style clip, clamp, notch, or other device effective in securing the lead 22 is attached to the lead. This optional clip can be permanently attached to the guide furthest away from the attached end of lead 24, the male plug 30, the female plug 28, or left unattached. The attached end of lead 24 can be nearest to either the male plug 30 or the female plug 28, if equipped, and should be placed on whatever end the manufacturer wishes.

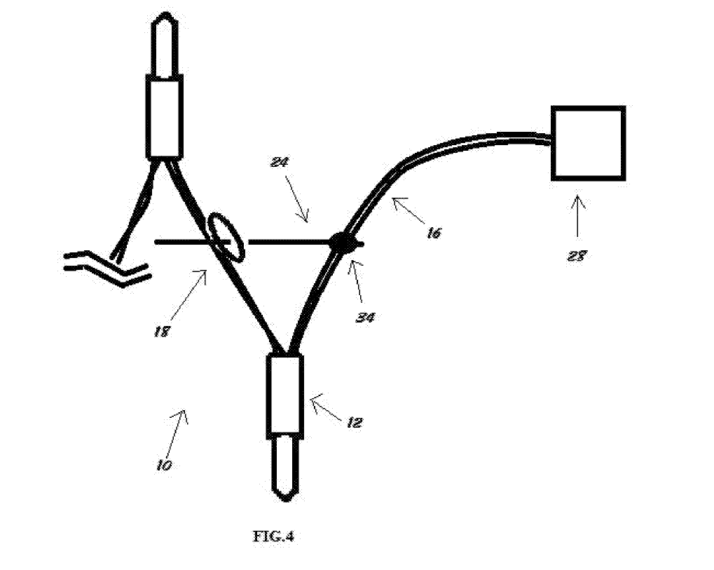

FIG. 4 is a detail of the attached end of the lead 24 when attached to the wires 16 of the light string with present invention 10. The lead 22 can be attached at the lead attachment point 34 with a tight knot, clamp, clip, or other simple and effective measure. This depiction shows the lead attachment point 34 nearest the female plug 28 of a light string, which is considered the best mode, but that should not restrict a manufacturer from having the lead attachment point 34 be nearest the male plug 30.

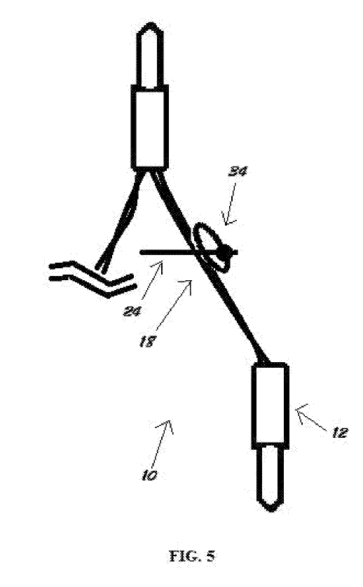

FIG. 5 is a detail of the attached end of the lead 24 when attached to a guide 20 of the light string with present invention 10. The lead 22 can be attached at the lead attachment point 34 with a tight knot, clamp, clip, or other simple and effective measure. The best mode is for the lead 22 to be attached to the wires 16, as the guide 20 used in this manner adds no benefit.

Having described my invention, I claim:

1. A light string storage system comprising:
a string of lights each individual light having a bulb and a socket;
a guide with opening attached at each of the mid-points between sockets; and
a lead of at least the length of said string of lights extending through the opening in each guide at each mid-point between sockets on said string, said lead being affixed to the said string or guide at one end of said string and extending beyond the guide at the opposite end of said string whereby pulling said lead will cause said mid-points between sockets to draw close until touching.

2. The light string storage system of claim 1 wherein said guide is plastic.

3. The light string storage system of claim 1 wherein said guide is glass.

4. The light string storage system of claim 1 wherein said guide is metal.

5. The light string storage system of claim 1 wherein said guide is wood.

6. The light string storage system of claim 1 wherein said guide is of other solid construction.

7. The light string storage system of claim 1 wherein said lead is nylon.

8. The light string storage system of claim 1 wherein said lead is ribbon.

9. The light string storage system of claim 1 wherein said lead is string.

10. The light string storage system of claim 1 wherein said lead is of other filamentary material.
